(19) United States
(12) Patent Application Publication
(10) Pub. No.: US 2013/0328541 A1
(43) Pub. Date: Dec. 12, 2013

(54) SUB-MODULE OF A MODULAR MULTI-STAGE CONVERTER

(71) Applicants: Ingo Euler, Erlangen (DE); Herbert Gambach, Uttenreuth (DE); Frank Schremmer, Fuerth (DE); Marcus Wahle, Fuerth (DE)

(72) Inventors: Ingo Euler, Erlangen (DE); Herbert Gambach, Uttenreuth (DE); Frank Schremmer, Fuerth (DE); Marcus Wahle, Fuerth (DE)

(73) Assignee: Siemens Aktiengesellschaft, Munchen (DE)

(21) Appl. No.: 14/001,531

(22) PCT Filed: Feb. 16, 2012
(86) PCT No.: PCT/EP12/52678

§ 371 Date: Aug. 26, 2013

(30) Foreign Application Priority Data
Feb. 25, 2011 (DE) 10 2011 004 733.6

(51) Int. Cl. H02M 3/155

(52) U.S. Cl. CPC H02M 3/155
USPC 323/311

(57) ABSTRACT

A sub-module for a modular multi-stage converter has an energy store and a power semiconductor series circuit connected in parallel to the energy store. In the semiconductor series circuit, two power semiconductor switches that can be activated and deactivated and have the same forward direction are connected in series. A free-wheeling diode is connected in parallel and in the opposite direction to each power semiconductor switch. A first connection terminal is connected to the energy store. A second connection terminal is connected to a potential point between the power semiconductor switches and to the free-wheeling diodes thereof. A bridging switch is disposed between the connection terminals for bridging the sub-module. The power semiconductors thereof are not destroyed upon closing the bridging switch and at least one connection terminal and/or a bridging branch that connects the two connection terminals to each other has an inductive component.

The invention relates to a submodule for a modular multistage converter having a unipolar energy store and a power semiconductor series circuit which is connected in parallel with the energy store and in which two power semiconductor switches which can be switched on and off and have the same forward direction are connected in series, a freewheeling diode being connected in opposition to and in parallel with each power semiconductor switch which can be switched on and off, a first terminal which is connected to the energy store, a second terminal which is connected to a potential point between the power semiconductor switches which can be switched on and off and the freewheeling diodes thereof, and a bridging switch in a bridging branch which connects the terminals to one another.

A submodule of this type is already known from DE 10 2005 040 543 A1, for example. That document discloses a so-called modular multistage converter which has a number of phase modules. Each phase module has a central AC voltage connection for connecting to the phases of an AC voltage power supply system. In addition, the phase module has two DC voltage connections at the ends. A phase module branch extends between the AC voltage connection and each of the two DC voltage connections. Each phase module branch in turn comprises a series circuit comprising bipolar submodules each of which has a unipolar capacitor as energy store. In the event of a fault, the voltage dropped across the capacitor is too large and so the submodule must be bridged in order to avoid greater damage. For this purpose, a bridging unit is provided which is arranged between the two terminals of each submodule. The bridging unit is an actuable power semiconductor.

It is known in practice that before a submodule of a modular multistage converter is short-circuited, the power semiconductor switches of the faulty submodule are blocked, that is, in other words, they are transferred into their blocking position. If the power semiconductor switches are no longer actuated in a submodule of this type, however, the energy store is charged further via the freewheeling diodes of the submodule with an appropriate current direction. In order to prevent even higher voltages across the energy store of the submodule, the terminals are therefore quickly short-circuited at a defined voltage. This short-circuit connection must be able to safely conduct the current flowing via the multistage converter, including possible surge currents, until the next maintenance interval.

In the event of the submodule being bridged, it may occur that the rapid closing of the bridging switch effects a hard commutation of the flow of current via a freewheeling diode such that the freewheeling diode is destroyed with subsequent short-circuiting of the capacitor as a result of an arc across the freewheeling diode and the closed short-circuiter. Moreover, in the event of return oscillation of the energy, further freewheeling diodes of the submodule can also be destroyed since the return oscillation current is only damped to a small extent and therefore can still contain amplitudes and energies which far exceed the permissible amount for the freewheeling diodes.

The problem addressed by the invention is therefore to provide a submodule of the type mentioned at the outset in which destruction of one or more freewheeling diodes is reliably avoided.

The invention solves this problem by means of at least one terminal and/or the bridging branch having an inductive component.

According to the invention, at least one inductance is arranged in the current path of the short-circuit current from the positive pole or the positive terminal of the energy store to the opposite pole thereof, said inductance being selected such that, firstly, an excessively rapid commutation owing to an excessively rapid rise in current is avoided. Secondly, no great losses occur in the case of conventional load current during normal operation as a result of the inductive component selected in accordance with the invention. By means of the inductive component or components, the current is therefore commutated more slowly, the loaded freewheeling diode being permitted to transition to the blocking position thereof and in this way to take up the voltage of the energy store. In this way, the energy store is prevented from discharging via said freewheeling diode and the bridging switch. For this reason, the remaining parts of the submodule are also not destroyed. Since high short-circuit currents and surge currents are avoided in accordance with the invention, the bridging switch can be configured for smaller maximum current strengths. This also applies to the rest of the components of the submodule, which otherwise would have to withstand the high current forces caused by the high short-circuit currents. Current forces in this sense occur in the event of parallel currents which can either attract or repel one another.

According to a first preferred variant of the invention, an inductive component is provided which is arranged either in one of the terminals or in the bridging branch.

According to an expedient configuration of the invention, each terminal has an inductive component. In this way, an even slower commutation of the current is ensured when the bridging switch is closed.

According to an expedient further development relating to this, a further inductive component is arranged in series with the bridging switch in the bridging branch. According to this advantageous configuration of the invention, the number of inductive components is increased even further with the result that an even better control of the commutation of the charging current from the freewheeling diode conducting the charging current is possible.

Advantageously, at least one inductive component is formed as an inductor coil. Inductor coils are available on the market at low cost and so the corresponding submodule also remains inexpensive.

However, according to one preferred configuration of the invention, at least one of the inductive components is configured as a ferrite core. Ferrite cores are likewise available on the market at low cost. They can also easily be inserted into previously existing systems.

Advantageously, the ferrite core is laminated. Laminated ferrite cores reduce the eddy-current losses in the ferrite core and therefore prevent intense heating of the inductive component during normal operation.

Further exemplary embodiments and advantages of the invention are the subject of the following description of exemplary embodiments, wherein identical reference signs refer to identically acting components and wherein

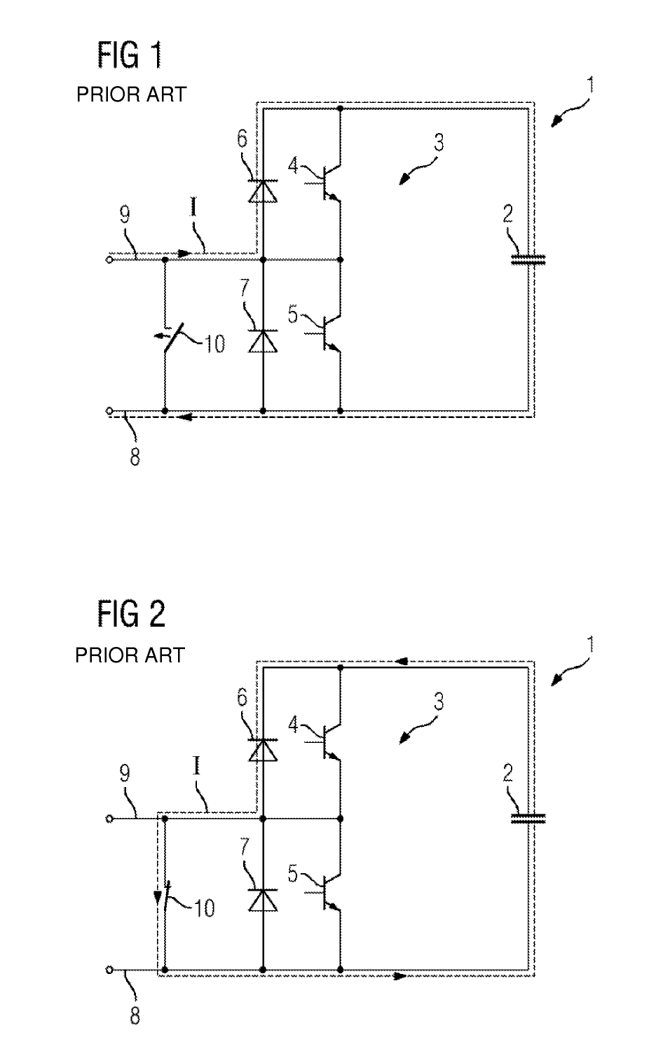

FIGS. 1 and 2 show a submodule according to the prior art and

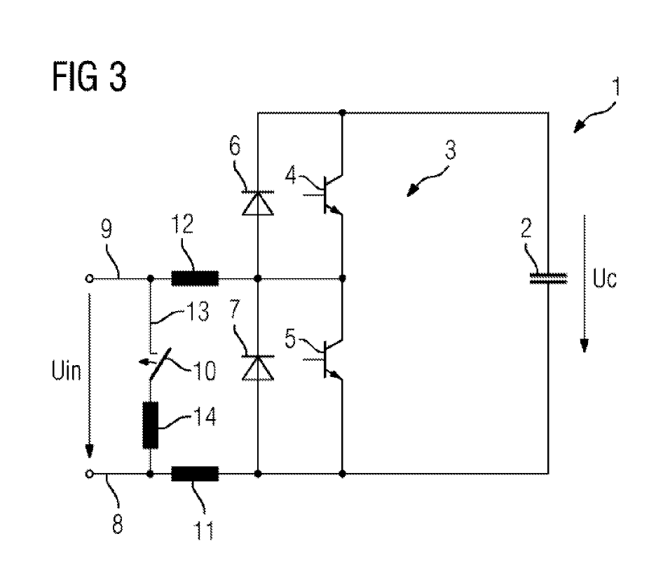

FIG. 3 shows an exemplary embodiment of the submodule according to the invention.

FIG. 1 shows an exemplary embodiment of a submodule 1 according to the prior art. Said submodule 1 has a unipolar storage capacitor 2 as energy store and a power semiconductor series circuit 3 which has two actuable power semiconductors 4 and 5 having the same forward direction and arranged in series with each other. Here, the actuable power semiconductor switches are so-called IGBT switches. In the context of the invention, however, other power semiconductor switches which can be switched on and off, such as GTO switches and IGCT switches, can be used. By means of a control signal, the power semiconductor switches 4 and 5 can be switched both on and off and configured for high voltages in the range of 1 kV to 10 kV. In the switched-on position thereof, a flow of current is possible via the power semiconductor switches only in the forward direction thereof. In the switched-off state thereof, they block the flow of current in both directions. A freewheeling diode 6 and 7 is connected in opposition to and in parallel with each of said power semiconductor switches 4 and 5. Each submodule 1 also has a first terminal 8, which is connected in this case to a pole of the storage capacitor 2. A second terminal 9 is connected to the potential point between the power semiconductor switches 4 and 5 and therefore to the potential point between the freewheeling diodes 6 and 7.

The direction of the flow of current is also indicated in FIG. 1 by arrows. In the state shown in FIG. 1, a charging current I flows from the second terminal 9 via the freewheeling diode 6, the storage capacitor 2 and the first terminal 8.

A bridging switch 10 is arranged between the terminals 8 and 9. If the bridging switch 10 is closed, as indicated in FIG. 1, when the charging current I flows via the freewheeling diode 6, a hard commutation of the current occurs and so the freewheeling diode 6 breaks down and remains conductive through the arc formed as a result. Once the bridging switch 10 has been closed, the storage capacitor 2 is therefore short-circuited. High discharging currents flow via the bridging switch 10. In the event of return oscillation of the energy, the freewheeling diode 7 is also destroyed. Owing to the high currents, correspondingly high mechanical forces occur since, depending on the direction of the current, parallel currents attract or repel each other.

FIG. 2 shows the short-circuit currents after the bridging switch 10 has been closed.

FIG. 3 shows an exemplary embodiment of the submodule 1 according to the invention, which differs from the submodule 1 shown in FIGS. 1 and 2 in that an inductive component 11 is arranged in the first terminal 8 and an inductive component 12 is arranged in the second terminal 9. It can also be seen that the bridging switch 10 is arranged in a bridging branch 13, wherein a third inductive component 14 is connected in series with the bridging switch in the bridging branch 13. The inductive components 11, 12 and 14 are in each case formed as laminated ferrite cores which were subsequently attached to the terminals 8, 9 and the bridging branch 13 by means of simple clamping. The ferrite cores 11, 12 and 14 limit the rise in current and effect a comparably slow commutation of the charging current I from the freewheeling diode 6, with the result that said freewheeling diode is able to undergo transition into the blocking position thereof in order to take up the capacitor voltage U_{c} in this way. Thus, the capacitor 2 is prevented from discharging.

In a departure from the exemplary embodiment shown in FIG. 3, the submodule 1 according to the invention can also have just a single inductive component 11, 12 or 14, which is arranged in one of the terminals 8, 9 or in the bridging branch 13. Said inductive component is, for example, likewise a laminated ferrite core.

1-6. (canceled)

7. A submodule for a modular multistage converter, the submodule comprising:
an unipolar energy store;
a power semiconductor series circuit connected in parallel with said energy store, said power semiconductor series circuit having two power semiconductor switches being switched on and off and having a same forward direction connected in series;
freewheeling diodes, one of said freewheeling diodes being connected in opposition to and in parallel with each of said power semiconductor switches;
a first terminal connected to said energy store;
a second terminal connected to a potential point between said power semiconductor switches and to said freewheeling diodes;
a bridging branch having a bridging switch and connecting said first and second the terminals to one another; and
at least one of said first terminal, said second terminal or said bridging branch having an inductive component.

8. The submodule according to claim 7, wherein each of said first and second terminals has one of said inductive component.

9. The submodule according to claim 8, wherein said inductive component is disposed in series with said bridging switch in said bridging branch.

10. The submodule according to claim 7, wherein said inductive component is an inductor coil.

11. The submodule according to claim 7, wherein said inductive component is a ferrite core.

12. The submodule according to claim 11, wherein said ferrite core is laminated.

13. The submodule according to claim 8, wherein said inductive component is an inductor coil.

14. The submodule according to claim 9, wherein said inductive component is an inductor coil.
